(19) United States
(12) Patent Application Publication
(10) Pub. No.: US 2008/0022311 A1
(43) Pub. Date: Jan. 24, 2008

(54) Receiving apparatus and receiving method

(75) Inventor: Takashi Narahara, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/604,749

(22) Filed: Nov. 28, 2006

(30) Foreign Application Priority Data
Jun. 30, 2006 (JP) 2006-182096

(51) Int. Cl. G06F 3/00; G06F 13/00; H04N 5/445

(52) U.S. Cl. 725/46; 725/39; 725/45

(57) ABSTRACT

A receiving apparatus includes an EPG acquisition unit acquiring EPG information from a broadcast wave, a receiving unit receiving recommended program information, a comparison unit comparing the received recommended program information and the acquired EPG information, and a display unit displaying the EPG based on a comparison result in the comparison unit and the acquired EPG information.

### CROSS-REFERENCE TO THE INVENTION

This application is based upon and claims the benefit of priority from the prior Japanese Patent Application No. 2006-182096, filed on Jun. 30, 2006; the entire contents of which are incorporated herein by reference.

### BACKGROUND OF THE INVENTION

1. Field of the Invention

The present invention relates to a receiving apparatus receiving a broadcast wave and a receiving method.

2. Description of the Related Art

A receiving apparatus receiving a broadcast wave for viewing a program is in use.

Here, a technology is disclosed in which electronic program guide information is used to check and select a program desired to be recorded or viewed (JP-A 2003-289493 (KOKAI)).

### SUMMARY OF THE INVENTION

Since numerous programs are broadcasted, it is not always easy for a viewer to select a program to view. Thus, in many cases, the viewer decides the program to view with reference to information of a recommended program (program recommended to be viewed) published in the newspaper or the like.

However, such information of the recommended program is not designed to be used directly on an electronic program guide, and is not necessarily convenient.

In view of the above, an object of the present invention is to provide a receiving apparatus and a receiving method enabling usage of there commended program information on the electronic program guide.

A receiving apparatus according to a mode of the present invention includes: an electronic program guide acquisition unit acquiring electronic program guide information from a broadcast wave; a receiving unit receiving recommended program information, a comparison unit comparing the received recommended program information and the acquired electronic program guide information; and a display unit displaying an electronic program guide based on a comparison result in the comparison unit and the acquired electronic program guide information.

A receiving method according to a mode of the present invention includes: acquiring electronic program guide information from a broadcast wave; receiving recommended program information; comparing the received recommended program information and the acquired electronic program guide information; and displaying an electronic program guide based on a result of the comparison and the acquired electronic program guide information.

### BRIEF DESCRIPTION OF THE DRAWINGS

FIG. 1 is a block diagram showing a receiving apparatus according to a first embodiment of the present invention.

FIG. 2 is a schematic view showing an example of recommended program information transmitted from the receiving apparatus to a recommended program server.

FIG. 3 is a schematic view showing an example of recommended program information transmitted from the recommended program server to the receiving apparatus.

FIG. 4 is a flowchart showing an entire processing procedure in the receiving apparatus in a case that an EPG is activated.

FIG. 5 is a flowchart showing a detail of the processing procedure of FIG. 4.

FIG. 6 is a flow chart showing a detail of the processing procedure of FIG. 4.

FIG. 7 is a flow chart showing a detail of the processing procedure of FIG. 4.

FIG. 8 is a flow chart showing a detail of the processing procedure of FIG. 4.

FIG. 9 is a flow chart showing a detail of the processing procedure of FIG. 4.

FIG. 10 is a view showing an example of a display screen of the EPG.

### DESCRIPTION OF THE EMBODIMENTS

Hereinafter, an embodiment of the present invention will be described in detail with reference to the drawings.

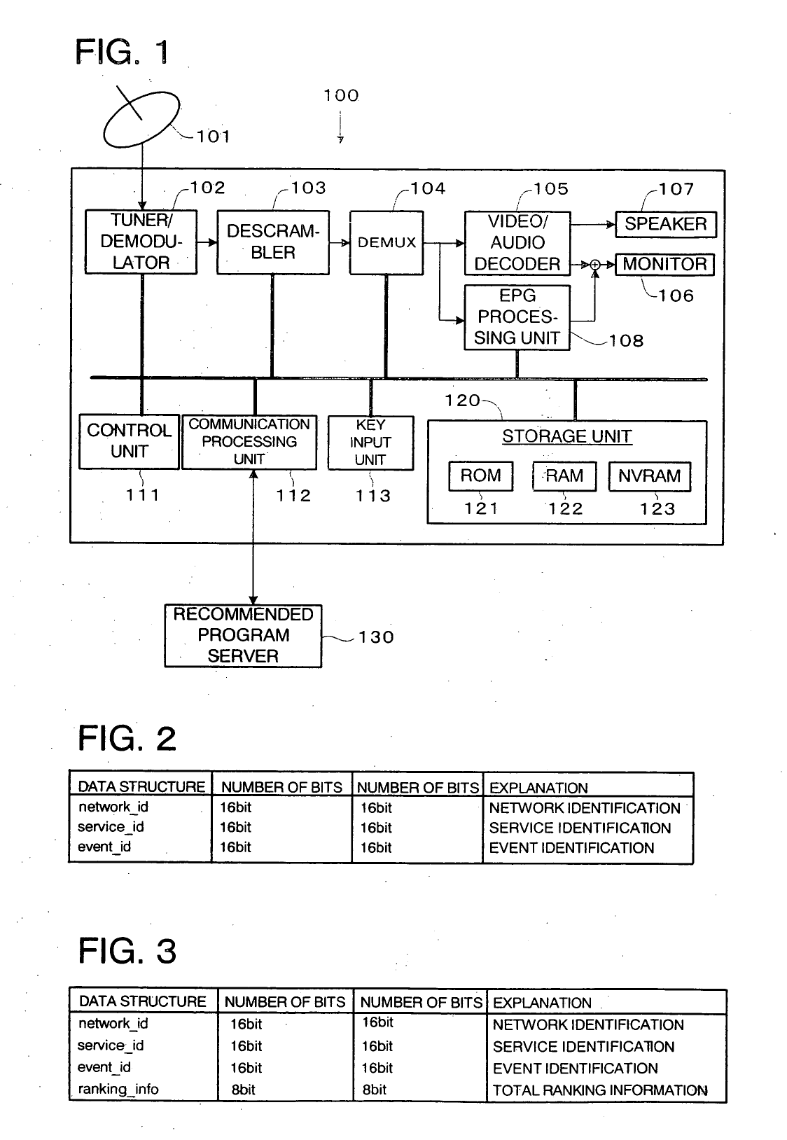

FIG. 1 is a block diagram showing a receiving apparatus 100 according to an embodiment of the present invention.

The receiving apparatus 100 is constituted with an antenna 101, a tuner/demodulator 102, a descrambler 103, a demultiplexing unit (DEMUX) 104, a video/audio decoder 105, a monitor 106, a speaker 107, an EPG processing unit 108, a control unit 111, a communication processing unit 112, a key input unit 113, and a storage unit 120.

The antenna 101 receives a broadcast wave transmitted from a broadcast station.

The tuner/demodulator 102 selects and demodulates a desired channel from the broadcast wave received by the antenna 101 to generate a transport stream (hereinafter, referred to as TS). The generated TS is outputted to the descrambler 103. This TS is a multiplexed signal including a scrambled broadcast program signal and SI/PSI. The scrambled broadcast program signal is a scrambled signal of a broadcast program signal of MPEG-2, for example.

The SI/PSI is program arrangement information. The SI includes an SDT (Service Definition Table), an EIT (Event Information Table), and the like. The SDT describes detailed information of a service (organization channel). The EIT describes detailed information of a program in the service. An EPG (Electronic Program Guide) is produced using mainly the EIT. The PSI describes a construction or the like of multiplexed plural programs and includes a PAT (Program Association Table), a PMT (Program Map Table) and the like.

The descrambler 103 descrambles the TS inputted from the tuner/demodulator 102 and outputs it to the demultiplexing unit 104. In other words, the scrambled broadcast program signal in the TS is descrambled so that the broadcast program signal is generated.

The demultiplexing unit 104 separates the broadcast program signal, SI/PSI data and the like from the TS inputted from the descrambler 103. Additionally, the demultiplexing unit 104 outputs the separated broadcast program signal to the video/audio decoder 105.

The video/audio decoder 105 decodes the broadcast program signal inputted from the demultiplexing unit 104 and outputs it to the monitor 106 and the speaker 107.

The monitor 106 is a display device such as a CRT and a liquid crystal display device. The speaker 107 is an audio output device.

The EPG processing unit 108 constructs EPG (Electronic Program Guide) information from the SI data separated by the demultiplexing unit 104 and further generates an image signal of the EPG. The EPG is displayed on the monitor 106 by this image signal. A user can check/reserve the program, using the EPG.

The EPG processing unit 108 functions as an acquisition unit acquiring the electronic program guide information from the broadcast wave. The EPG processing unit 108 functions as a display unit displaying the electronic program guide based on a comparison result of recommended program information and the electronic program guide information as well as the electronic program guide information.

The control unit 111 is constituted with a CPU (central Processing Unit) and controls the entire receiving apparatus 100. The control unit 111 functions as a comparison unit comparing the recommended program information and the electronic program guide information.

The communication processing unit 112 is a communication device such as a modem, and transmits/receives there commended program data between a recommended program server 130 and the communication processing unit 112 via a network such as Internet.

The recommended program server 130 has a database in which recommended program information is registered. The recommended program server 130 accumulates the recommended program information transmitted from a plurality of receiving apparatuses 100 in the database and ranks the respective programs based on the number of recommendation.

FIG. 2 is a schematic view showing an example of the recommended program information transmitted to the recommended program server 130.

As sown in FIG. 2, the recommended program information to be transmitted includes a network ID (network_id), a service ID (service_id), and an event ID (event_id) of 16 bit width respectively. A combination of these data functions as recommended program identification information identifying the recommended program uniquely. By transmitting the recommended program information, the recommended program information is accumulated in the recommended program server 130.

The network ID is an identifier of a network of the broadcast program. By the network ID, the TS transmitted by a broadcast distribution system (broadcast affiliate) can be identified from the TS transmitted by another broadcast distribution system.

The service ID is an identifier of a service. This service means a continuous schedule of the broadcast program made by a broadcasting business.

The event ID is an identifier of an event. The event is an aggregate of the TS's belonging to the same service, the aggregate having a specified starting time and a specified ending time, and the event corresponds to one program such as a news or a drama.

FIG. 3 is a schematic view showing an example of the recommended program information received from the recommended program server 130.

As shown in FIG. 3, the recommended program information to be received includes the network ID (network_id), the service ID (service_id), the event ID (event_id) and ranking data (ranking_info).

The combination of the network ID (network_id), the service ID (service_id) and the event ID (event_id) functions as the recommended program identification information identifying the recommended program uniquely.

The ranking data (ranking_info) indicates a ranking (order) of the program by 8 bit, that is, an integer value from 0 to 255. By the ranking data, the ranking of the recommended program can be displayed on the EPG.

The recommended program information to be received can be additionally provided with a category of the recommended program. In this case, the ranking data can indicate the ranking of the recommended program in that category. In this case, the category of the recommended program and the ranking in the category can be displayed on the EPG.

The key input unit 113 is an input device, for example a keyboard, for inputting user operation information. As user operations, focus moving for selecting the program, activation of a menu, termination of the EPG and the like can be quoted. The key input unit 113 has a direction key and a menu activation key. A focus can be moved to the program (program is selected) by pressing the direction key. A menu P5 described later can be displayed by pressing the menu activation key.

A storage unit 120 is constituted with a ROM (Read Only Memory) 121, a RAM (RandomAccessMemory) 122 and a NVRAM (Non Volatile RAM) 123.

In the RAM 122 and the NVRAM 123, the recommended program information is stored. Normally, the recommended program is displayed on the EPG, using the recommended program information stored in the RAM 122. The NVRAM 123 is used for EPG display at a time of activation or the like of the receiving apparatus 100. The NVRAM 123 can hold the recommended program information even when the receiving apparatus 100 is halted. Therefore, the recommended program can be displayed on the EPG without receiving the recommended program information from the recommended program server 130. Since the reception from the recommended program server 130 is unnecessary, the recommended program can be displayed quickly.

### (Operation of Receiving Apparatus 100)

Hereinafter, an operational procedure of the receiving apparatus 100 will be described.

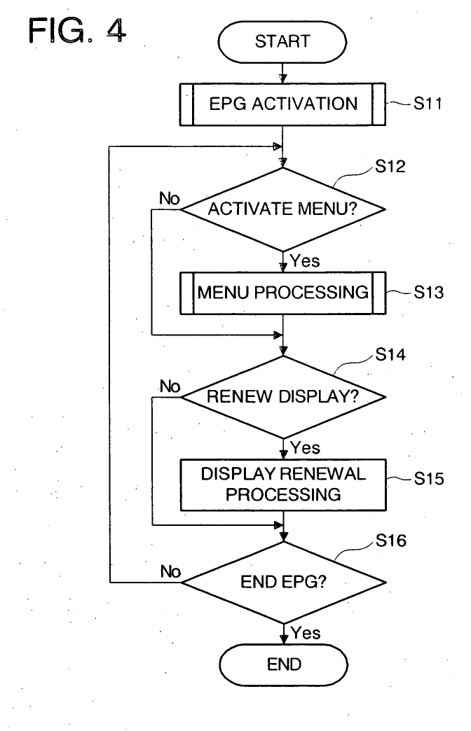

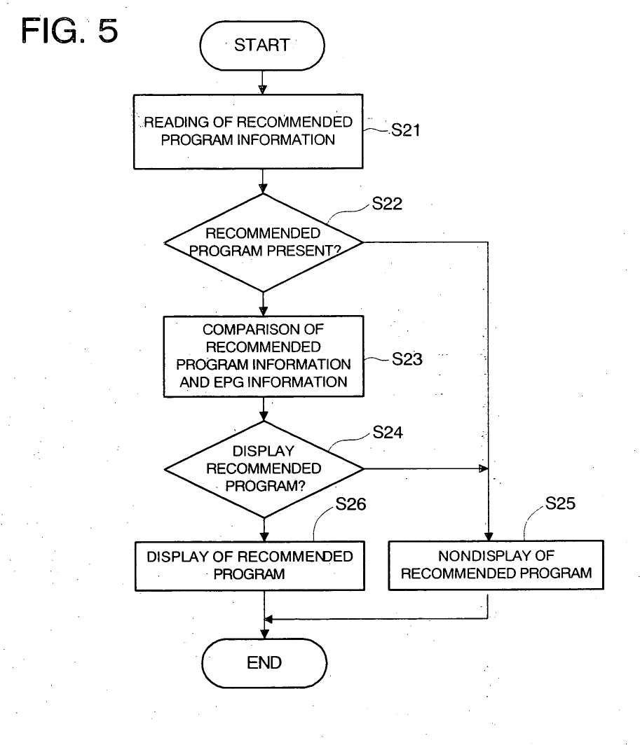

FIG. 4 is a flowchart showing an entire processing procedure in the receiving apparatus in a case that the EPG is activated. FIG. 5 to FIG. 9 are flowcharts showing details of the processing procedure of FIG. 4.

### A. Activation Processing (Step S11)

The EPG is activated based on a user's operation. FIG. 5 is the flowchart showing the detail of this activation procedure.

### (1) Reading of Recommended Program Information (Step S21)

The recommended program information is read from the RAM 122 or the NVRAM 123. Here, the recommended program information to be read can be equivalent to the recommended program information received from the recommended program server 130 (see FIG. 3).

The recommended program information can be acquired from the recommended program server 130. However, it is afraid that an activation time of the EPG becomes long if the recommended program information is acquired from the recommended program server 130 every time the EPG is activated. Therefore, at the time of activation of the EPG, the recommended program data is to be acquired from the RAM 122 or the NVRAM 123.

After a power supply of the receiving apparatus 100 is turned on, at the time of the fist activation of the EPG, the recommended program information is acquired from the NVRM 123 and the acquired recommended program information is copied to the RAM 122. It is because the recommended program information in the RAM 122 is not held when the power supply of the receiving apparatus 100 is turned off.

Thereafter, the recommended program information is acquired from the RAM 122 and used for the display of the EPG until the power supply of the receiving apparatus 100 is turned off. Additionally, when the recommended program information is received from the recommended program server 130, the recommended program information in the RAM 122 is re-written. It is for the purpose of making the RAM 122 store the newest recommended program information.

When the power supply of the receiving apparatus 100 is turned off, the recommended program information in the RAM 122 is written in the NVRAM 123. It is for the purpose of making the recommended program information stored in the NVRAM 123 as new as possible.

### (2) Judgment of Presence/Absence of Recommended Program to be EPG Displayed (Steps S22 to S24)

After the recommended program information is read, it is judged whether the recommended program exists or not (Step S22). It is because there is no display of the recommended program if the recommended program itself does not exist.

If the recommended program exists, the recommended program information and the EPG information are compared. In other words, it is judged whether the recommended program identification information (network ID, service ID and event ID) coincides or not between the recommended program and the program to be displayed in the EPG. Incidentally, the EPG information is generated from the TS by the EPG processing unit 108.

By a result of the above judgment, it is judged whether the recommended program is displayed or not.

### (3) EPG Display (Steps S 25, S26)

The EPG is displayed in response to the results of the judgments of the steps S22 and S24. In other words, if the judgment result of either of the step S22 or the step S24 is “No”, usual EPG display is carried out. If the judgment result of the step S24 is “Yes” (if the recommended program identification information coincides), the recommended program is displayed in the EPG.

FIG. 10 is a view showing an example of a display screen of the EPG.

Icons P1 and P2 are icons indicating that the rankings of the recommended programs are the first and the third respectively. Here, programs A1 and B2 are the first and the third respectively in the ranking of the recommended program.

These icons P1 and P2 are decided based on ranking data in the recommended program information.

A denotation P3 indicates an explanation to make the user recognize a meaning of the icon of the recommended program.

A highlighting P4 indicates that a focus is given to the program A1 (program A1 is selected) by the user's operation. Various processings are possible for the program to which the focus is given.

A menu P5 displays the menu available to the user. The menu P5 is displayed by the user's operation. When the menu P5 is displayed, the user's operation is reflected on the menu P5, not on the EPG.

In the menu P5, buttons P6 to P8 are arranged. The button P6 is a button for acquiring the recommended program information. The button P7 is a button for reserving the program and transmitting the recommended program information. The button 8 is a button for transmitting the recommended program information. By the user's operation, the focus is moved to the buttons P6 to P8 so that the respective processings are selected and carried out. Here, a state in which the focus is given to the button P6 is shown.

A denotation P9 indicates an explanation to make the user recognize a meaning of the icon of the reserved program.

An icon P10 is an icon indicating that the program is reserved to be viewed or stored. Here, it is indicated that the program B1 is reserved to be viewed or stored.

### B. Menu Processing (Steps S12, S13)

After the EPG is activated, user operation information is inputted by the key input unit 113. These user's operations include focus movement for program selection, activation of the menu, termination of the EPG and the like.

The focus is moved to the program by a pressing down or the like of the direction key of the key input unit 113 (program is selected). By pressing down a menu activation key of the key input unit 113 in a state that the program is selected, the menu P5 is displayed and the processing to that program can be selected.

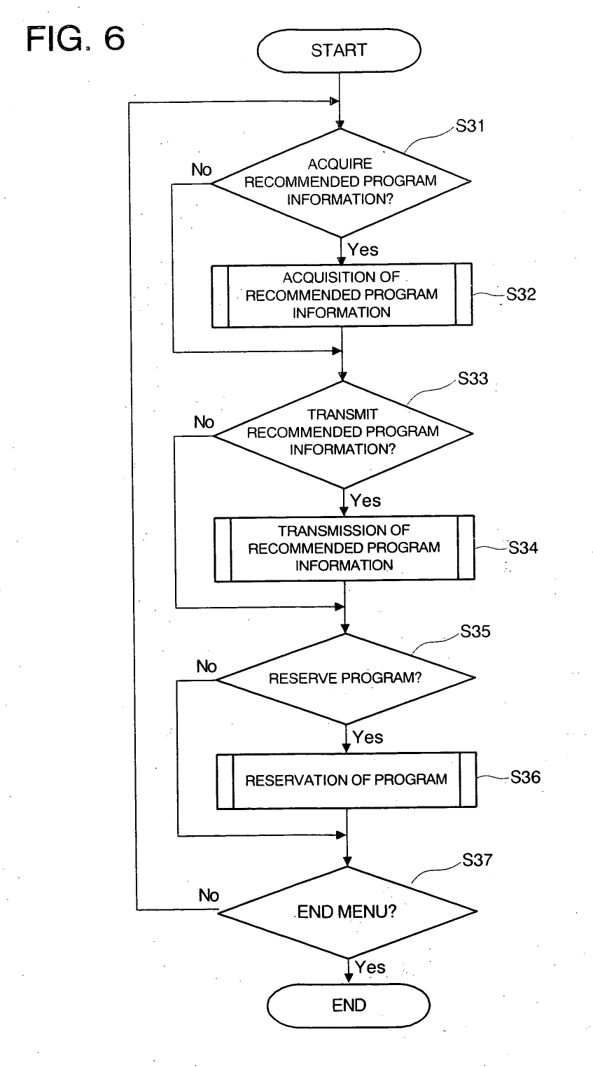

FIG. 6 is a flowchart showing a detail of the menu processing of the step S13.

The menu P5 is displayed, and the buttons P6 to P8 (recommended program information acquisition, program reservation and information transmission, recommended program information transmission) are selected by the user's operation (steps S31 to S36).

These processings are repeated until the menu processing is terminated by the user's operation (step S37).

### (1) Acquisition of Recommended Program Information

If the recommended program information acquisition is selected, a recommended program information acquisition processing is carried out (step S32).

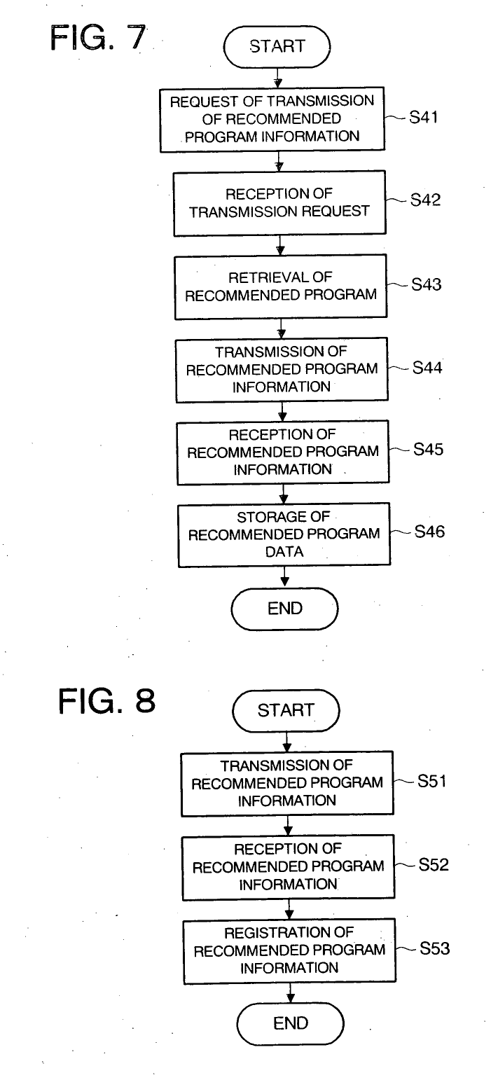

FIG. 7 is a flowchart showing a detail of the recommended program information acquisition processing of the step S32.

Acquisition of the recommended program information is requested from the receiving apparatus 100 to the recommended program server 130 (step S41). In other words, information of requesting transmission of the recommended program information (recommended program information transmission request) is transmitted from the communication processing unit 112 to the recommended program server 130.

If the recommended program information transmission request is received by the recommended program server 130, the recommended program server 130 retrieves the recommended program information in the database (steps S42, S43)

The recommended program information transmitted from the recommended program server 130 is received by the receiving apparatus 100 which has transmitted the recommended program information request (steps S44, S45). The receiving apparatus 100 stores the received recommended program information in the RAM 122 (step S46).

Incidentally, the receiving apparatus 100 receives combinations of the network ID (network_id), the service ID (service_id), the event ID (event_id) and the ranking data (ranking_info) shown in FIG. 3, the number of combinations being the same as the number of the recommended programs.

### (2) Transmission of Recommended Program Information

If the button P8 (recommended program information transmission) of the menu P5 is selected, recommended program information about the program to which the focus is given by the highlighting P4 is transmitted (step S34).

FIG. 8 is a flowchart showing a detail of the recommended program information transmission processing of the step S34.

The recommended program information is transmitted from the communication processing unit 112 to the recommended program server 130 (step S51). The recommended program server 130 receives the recommended program information and registers the recommended program information in the database (steps S52, S53).

Incidentally, the receiving apparatus 100 transmits the combination of the network ID (network_id), the service ID (service_id) and the event ID (event_id) shown in FIG. 2.

### (3) Transmission of Program Reservation

If the button 7 (program reservation and information transmission) of the menu P5 is selected, the program reservation and the recommended program information about the program to which the focus is given by the highlighting P4 is transmitted (step S36).

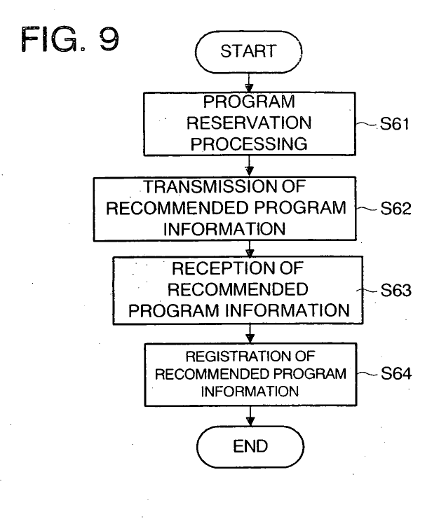

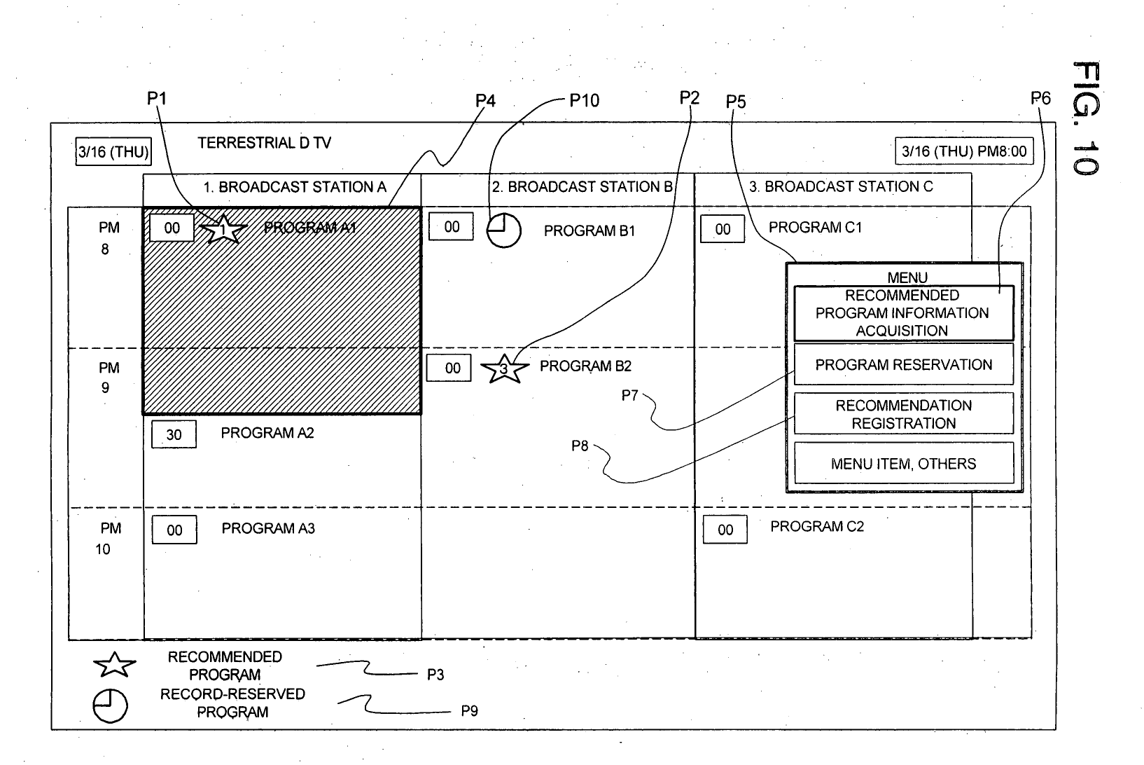

FIG. 9 is a flowchart showing a detail of the program reservation and the information transmission processing of the step S36.

The program is reserved by the EPG (step S61). At the time of this program reservation processing, reserved program information is written into the NVRAM 123.

Next, the recommended program information is transmitted from the communication processing unit 112 to the recommended program server 130 (step S62). The recommended program server 130 receives the recommended program information and registers the recommended program information in the database (steps S63, S64).

Incidentally, the receiving apparatus 100 transmits the combination of the network ID (network_id), the service ID (service_id) and the event ID (event_id) shown in FIG. 2.

### C. Renewal of EPG Display (Step S14, S15)

If the display of the menu P5 is terminated or a displayed time zone of the EPG is moved by the movement of the focus, it is judged whether renewal of the display is necessary or not (step S14). This judgment is carried out in accordance with substantially the same procedures as those of the existing steps S22 to S24, based on the existence/absence of the recommended program and existence /absence of the reserved program.

Based on the recommended program information stored in the RAM 122, it is judged whether the recommended program exists or not. If the recommended program exists, the recommend program information and the EPG information are compared. In other words, it is judged whether the recommended program identification information (network ID, service ID, event ID) coincides or not between the recommended program and the program displayed on the EPG.

By this judgment result, whether the recommended program is displayed on the EPG or not is determined. If the recommended program identification information coincides, based on the ranking data of the recommended program information, the icon (for example, the icons P1, P2 in FIG. 10) corresponding to the ranking is displayed in the EPG.

Additionally, it is judged whether the reserved program identification information (network ID, service ID, event ID) coincides or not between the reserved program and the program displayed on the EPG. As described above, the icon P10 indicates that the program is reserved.

The above processings are repeated until the EPG is terminated by the user's operation (step S16).

### Other Embodiments

The embodiment of the present invention is not limited to the above embodiment and can be expanded or modified, and an expanded or modified embodiment is included in the technical scope of the present invention.

For example, ranking information per category may be added to the recommended program information received from the recommended program server 130 so that the ranking information per category can be obtained. Also, an icon indicating the ranking per category may be added to the EPG screen so that an order per ranking can be displayed.

What is claimed is:

1. A receiving apparatus, comprising:
an acquisition unit acquiring electronic program guide information from a broadcast wave;
a receiving unit receiving recommended program information,
a comparison unit comparing the received recommended program information and the acquired electronic program guide information; and
a display unit displaying an electronic program guide based on a comparison result in the comparison unit and the acquired electronic program guide information.

2. The receiving apparatus according to claim 1,
wherein the recommended program information to be received includes recommended program identification information and ranking information of a recommended program indicated by the recommended program identification information, and
wherein the display unit displays the recommended program on the electronic program guide based on the ranking information.

3. The receiving apparatus as set froth in claim 1, further comprising:
a nonvolatile memory storing the recommended program information to be received,
wherein, when the electronic program guide is displayed at the first time since the receiving apparatus is activated, the display unit displays the electronic program guide based on the stored electronic program guide information.

4. The receiving apparatus according to claim 1, further comprising:
a transmission unit transmitting recommended program information.

5. A receiving method, comprising:
acquiring electronic program guide information from a broadcast wave;
receiving recommended program information;
comparing the received recommended program information and the acquired electronic program guide information; and
displaying an electronic program guide based on a result of the comparison and the acquired electronic program guide information.

6. The receiving method according to claim 5,
wherein the recommended program information to be received includes recommended program identification information and ranking information of a recommended program indicated by the recommended program identification information, and
wherein, in the displaying, a recommended program is displayed on the electronic program guide based on the ranking information.

7. The receiving method according to claim 5, further comprising storing the recommended program information to be received in a nonvolatile memory,
wherein, when the electronic program guide is displayed at the first time since the receiving apparatus is activated, the electronic program guide is displayed based on the stored electronic program guide information in the displaying.

8. The receiving method according to claim 5, further comprising transmitting recommended program information.
